(19) United States
(12) Patent Application Publication
(10) Pub. No.: US 2020/0189396 A1
(43) Pub. Date: Jun. 18, 2020

(54) COLLECTOR SHOE AND CURRENT COLLECTOR

(71) Applicant: CENTRAL JAPAN RAILWAY COMPANY, Nagoya-shi, Aichi (JP)

(72) Inventors: Kei SAKANOUE, Nagoya-shi (JP); Isao NARUSE, Nagoya-shi (JP); Kotaro NAKAMURA, Nagoya-shi (JP); Kazuki TANAKA, Nagoya-shi (JP)

(73) Assignee: Central Japan Railway Company, Nagoya-shi, Aichi (JP)

(21) Appl. No.: 16/322,723

(22) PCT Filed: Aug. 2, 2016
(86) PCT No.: PCT/JP2016/072669

§ 371 Date: Feb. 1, 2019

(51) Int. Cl. B60L 5/08; B60L 5/40

(52) U.S. Cl. CPC B60L 5/08; B60L 2200/26; B60L 5/40

(57) ABSTRACT

A collector shoe is provided. The collector shoe in one aspect of the present disclosure includes a shoe body, a sliding plate disposed on a top surface of the shoe body, and an electrically conductive member disposed on a front and/or rear side surface of the shoe body.

### TECHNICAL FIELD

The present disclosure relates to a collector shoe and a current collector.

### BACKGROUND ART

Current collectors are mounted on roofs of railway vehicles. A current collector includes a structure to support a collector shoe by a current collecting arm. The collector shoe includes a shoe body, and a sliding plate attached to a top surface of the shoe body. The current collector presses the sliding plate of the collector shoe against a bottom edge of an overhead line and takes electricity from the overhead line to a train (see Patent Document 1).

### PRIOR ART DOCUMENTS

### Patent Documents

Patent Document 1: Japanese Patent No. 4386253

### SUMMARY OF THE INVENTION

### Problems to be Solved by the Invention

An arc is generated when a sliding plate is pressed against an overhead line, which sometimes erodes a shoe body.

Desirably, one aspect of the present disclosure is to provide a collector shoe and a current collector that can reduce erosion of the shoe body.

### Means for Solving the Problems

A collector shoe in the present disclosure comprises a shoe body, a sliding plate disposed on a top surface of the shoe body, and an electrically conductive member disposed on a front and/or rear side surface of the shoe body.

By comprising the electrically conductive member disposed on the front and/or rear side surface of the shoe body, the collector shoe in the present disclosure can reduce erosion of the shoe body by an arc.

A current collector in the present disclosure comprises the aforementioned collector shoe. By comprising the electrically conductive member disposed on the front and/or rear side surface of the shoe body, the current collector in the present disclosure can reduce erosion of the shoe body by the arc.

### BRIEF DESCRIPTION OF THE DRAWINGS

FIG. 1 is a perspective view showing a configuration of a current collector.

FIG. 2 is a plan view showing a configuration of a collector shoe.

FIG. 3 is a side view showing a configuration of a collector shoe.

FIG. 4 is a cross-sectional view taken along line IV-IV in FIG. 2.

FIG. 5 is a cross-sectional view of a collector shoe.

FIG. 6 is a cross-sectional view of a collector shoe.

FIG. 7 is a cross-sectional view of a collector shoe.

FIG. 8 is a cross-sectional view of a collector shoe.

FIG. 9 is a cross-sectional view of a collector shoe.

FIG. 10 is a cross-sectional view of a collector shoe.

FIG. 11 is a side view showing a configuration of a collector shoe.

### EXPLANATION OF REFERENCE NUMERALS

1 . . . current collector, 3 . . . vehicle, 4 . . . roof, 5, 6 . . . insulator, 7 . . . base, 8 . . . collector shoe, 9 . . . current collecting arm, 10 . . . windshield, 11 . . . shoe body, 13 . . . sliding plate, 15 . . . front conductive member, 16 . . . rear conductive member, 15A, 16A . . . long leg, 15B, 16B . . . short leg, 17 . . . top surface, 19 . . . front surface, 19A . . . upper end, 21 . . . rear surface, 21A . . . upper end, 23, 27, 31 . . . front recess, 25, 29, 33 . . . rear recess

### MODE FOR CARRYING OUT THE INVENTION

Example embodiments of the present disclosure will be described with reference to the drawings.

### First Embodiment

1. Configuration of Current Collector 1

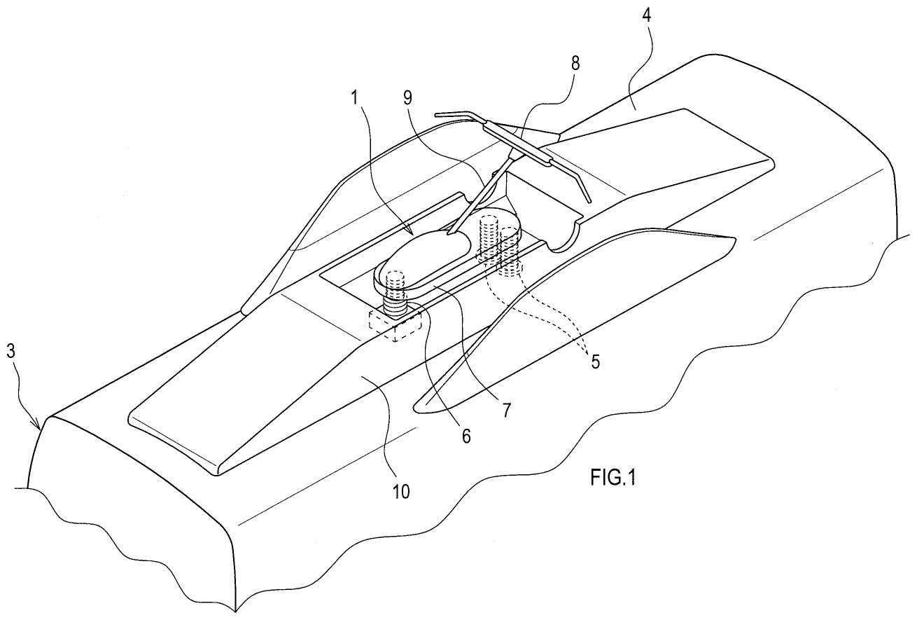

A configuration of the current collector 1 will be explained with reference to FIG. 1. The current collector 1 is disposed on a roof 4 of a vehicle 3. The current collector 1 comprises insulators 5, 5, 6, a base 7, a collector shoe 8, and a current collecting arm 9.

The insulators 5, 5, 6 fix the base 7 on the roof 4. The current collecting arm 9 extends obliquely upward from one side to the other side of front-rear directions of the base 7 (travelling directions of the vehicle 3) and supports the collector shoe 8. The collector shoe 8 contacts an overhead line, which is not shown, and takes electricity from the overhead line to the vehicle 3. Specific configuration of the collector shoe 8 will be explained later. A windshield 10 for reducing wind noise generated at the current collector 1 is disposed on the roof 4.

2. Configuration of Collector Shoe 8

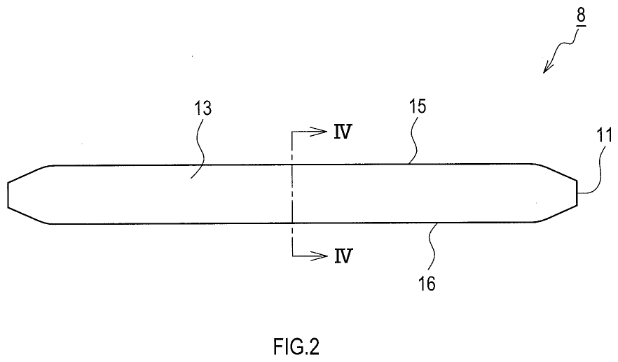

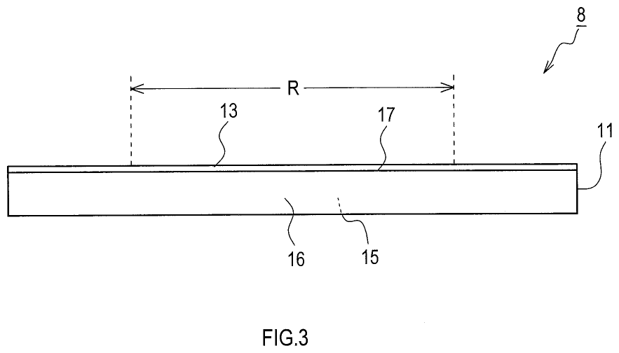

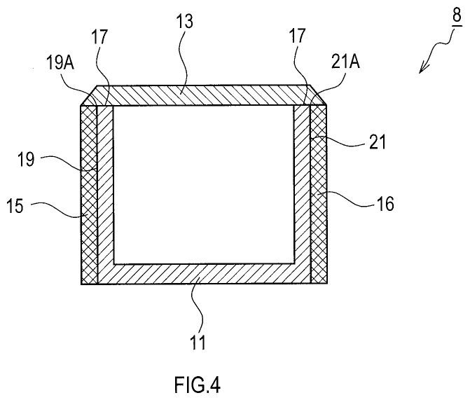

A configuration of the collector shoe 8 will be explained with reference to FIG. 2 to FIG. 4. Horns are omitted in FIG. 2 and FIG. 3. The collector shoe 8 has a shape of a prism. The collector shoe 8 is attached to the current collector 1 such that longitudinal directions of the collector shoe 8 are parallel with width directions of the vehicle 3. Hereinafter, the longitudinal directions of the collector shoe 8 may also be referred to as the width directions of the collector shoe 8. Also, up-down directions of the collector shoe 8, attached to the current collector 1, may also be referred to as up-down directions of the collector shoe 8.

The collector shoe 8 comprises a shoe body 11, a sliding plate 13, a front conductive member 15, and a rear conductive member 16. The shoe body 11 includes metal. The shoe body 11 has a shape of a prism as a whole. Longitudinal directions of the shoe body 11 conform to the width directions of the collector shoe 8. The front conductive member 15 and the rear conductive member 16 are one example of an electrically conductive member.

When the collector shoe 8 is attached to the current collector 1, a surface of the shoe body 11 positioned at the top of the shoe body 11 is a top surface 17; a side surface of the shoe body 11 positioned at the front side in the travelling directions of the vehicle 3 is a front surface 19; and a side surface of the shoe body 11 positioned at the rear side of the travelling directions of the vehicle 3 is a rear surface 21. The shoe body 11 has a U-shape with an opening at the top surface 17 when viewed in a vertical cross section orthogonal to the width directions (a vertical cross section along the front-rear directions).

The sliding plate 13 is a plate member that includes a metal or carbon material. The sliding plate 13 is attached to the top surface 17 of the shoe body 11. The sliding plate 13 entirely covers the shoe body 11 in the width directions. The sliding plate 13 also entirely covers the shoe body 11 in horizontal directions (hereinafter referred to as the front-rear directions) orthogonal to the width directions.

The front conductive member 15 and the rear conductive member 16 are plate members including a metal or carbon material (for example, metallized carbon). The front conductive member 15 is attached to the front surface 19; the rear conductive member 16 is attached to the rear surface 21. The front conductive member 15 and the rear conductive member 16 can be attached with bolts and nuts, which are not shown.

The front conductive member 15 covers an upper end 19A of the front surface 19. The front conductive member 15 covers most of the front surface 19 (exceeding a half of the entire area) in the up-down directions. The front conductive member 15 entirely covers the front surface 19 in the width directions. Accordingly, the front conductive member 15 covers an area R (see, FIG. 3) of the front surface 19 in the width directions; the area R is where the sliding plate 13 contacts the overhead line. The area R is determined unambiguously in accordance with a standard of the overhead line.

The rear conductive member 16 covers an upper end 21A of the rear surface 21. The rear conductive member 16 covers most of the rear surface 21 (exceeding a half of the entire area) in the up-down directions. The rear conductive member 16 entirely covers the rear surface 21 in the width directions. Accordingly, the rear conductive member 16 covers the area R of the rear surface 21 in the width directions.

3. Effects of Current Collector 1 and Collector Shoe 8

(1A) The collector shoe 8 comprises the front conductive member 15 on the front surface 19 of the shoe body, and the rear conductive member 16 on the rear surface 21. This reduces erosion of the shoe body 11 by an arc generated by the contact between the overhead line and the sliding plate 13.

(1B) The arc generally tends to spread around the upper ends 19A, 21A since the upper ends 19A, 21A are close to the sliding plate 13 and the overhead line. Since the front conductive member 15 covers the upper end 19A, and the rear conductive member 16 covers the upper end 21A, the erosion of the shoe body 11 by the arc can be further reduced.

(1C) The front conductive member 15 entirely covers the front surface 19 in the up-down directions. The rear conductive member 16 entirely covers the rear surface 21 in the up-down directions. Accordingly, the erosion of the shoe body 11 by the arc can be further reduced.

(1D) The area R is generally an area where the arc tends to spread. The front conductive member 15 covers the area R of the front surface 19 in the width directions; and the rear conductive member 16 covers the area R of the rear surface 21 in the width directions. This further reduces the erosion of the shoe body 11 by the arc.

### Second Embodiment

1. Configuration of Current Collector 1 and Collector Shoe 8

Configuration of the current collector 1 and the collector shoe 8 in the present embodiment is basically in common with, but partially different from, the configuration in the first embodiment. Hereinafter, common configuration will be omitted or explained in brief, and differences in the configuration will be mainly explained.

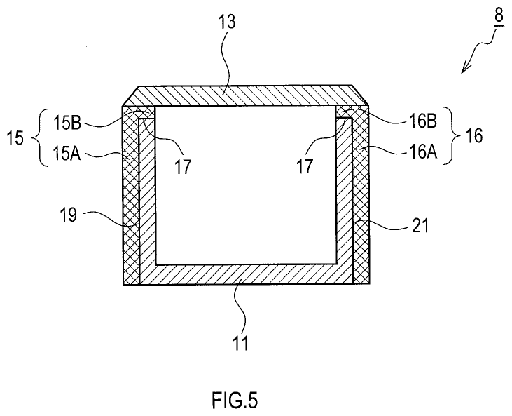

As shown in FIG. 5, the front conductive member 15 has an L-shape with its long leg 15A and its short leg 15B creating a right angle when viewed in the vertical cross section orthogonal to the width directions. The front conductive member 15 is attached to the front surface 19 such that the short leg 15B sits on the top surface 17 of the shoe body 11. The long leg 15A entirely covers the front surface 19 in the up-down directions.

Likewise, the rear conductive member 16 has an L-shape with its long leg 16A and its short leg 16B creating a right angle. The rear conductive member 16 is attached to the rear surface 21 such that the short leg 16B sits on the top surface 17 of the shoe body 11. The long leg 16A entirely covers the rear surface 21 in the up-down directions.

3. Effect of Current Collector 1 and Collector Shoe 8

According to the second embodiment, which is explained above in detail, the following effect can be obtained in addition to the aforementioned effects (1A) to (1D) in the first embodiment.

(2A) The front conductive member 15 is attached to the front surface 19 such that the short leg 15B sits on the top surface 17 of the shoe body 11. Also, the rear conductive member 16 is attached to the rear surface 21 such that the short leg 16B sits on the top surface 17 of the shoe body 11. Accordingly, the front conductive member 15 and the rear conductive member 16 are inhibited from dropping from the shoe body 11.

### Third Embodiment

1. Configuration of Current Collector 1 and Collector Shoe 8

Configuration of the current collector 1 and the collector shoe 8 in the present embodiment is basically in common with, but partially different from, the configuration in the first embodiment. Hereinafter, common configuration will be omitted or explained in brief, and differences in the configuration will be mainly explained.

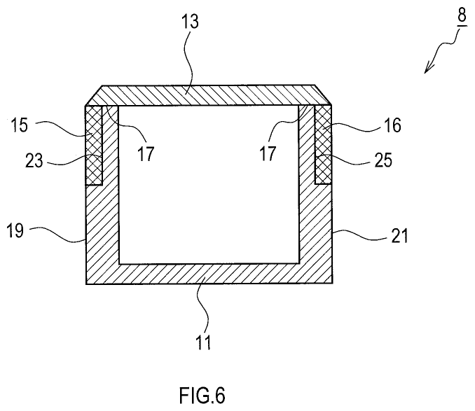

As shown in FIG. 6, the shoe body 11 comprises a front recess 23 and a rear recess 25 when viewed in the vertical cross section orthogonal to the width directions. The front recess 23 is a portion of the front surface 19 having a shape which is recessed relative to the surrounding portion of the front surface 19. The front recess 23 extends from the top surface 17 to the center of the front surface 19 in the up-down directions. The front recess 23 and the rear recess 25 are one example of a recess.

The rear recess 25 is on the rear surface 21 and has a shape which is recessed relative to the surrounding portion of the rear surface 21. The rear recess 25 extends from the top surface 17 to the center of the rear surface 21 in the up-down directions.

The front conductive member 15 is entirely fitted into the front recess 23. The rear conductive member 16 is entirely fitted into the rear recess 25.

3. Effect of Current Collector 1 and Collector Shoe 8

According to the third embodiment, which is explained above in detail, the following effect can be obtained in addition to the aforementioned effects (1A) to (1D) in the first embodiment.

(3A) The front conductive member 15 is fitted into the front recess 23, and the rear conductive member 16 is fitted into the rear recess 25. Accordingly, the front conductive member 15 and the rear conductive member 16 are inhibited from dropping from the shoe body 11.

### Fourth Embodiment

1. Configuration of Current Collector 1 and Collector Shoe 8

Configuration of the current collector 1 and the collector shoe 8 in the present embodiment is basically in common with, but partially different from, the configuration in the first embodiment. Hereinafter, common configuration will be omitted or explained in brief, and differences in the configuration will be mainly explained.

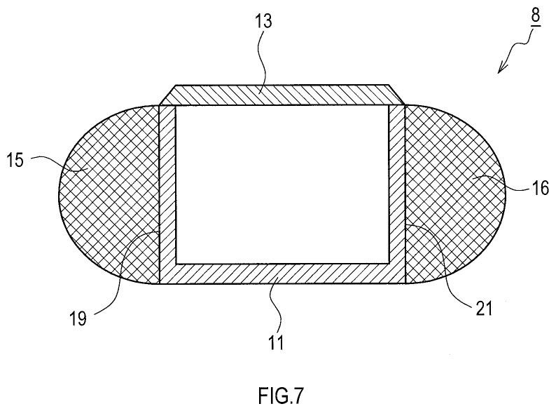

As shown in FIG. 7, an outer surface of the front conductive member 15 and an outer surface of the rear conductive member 16 have an arc-shape when viewed in the vertical cross section orthogonal to the width directions.

3. Effect of Current Collector 1 and Collector Shoe 8

According to the fourth embodiment, which is explained above in detail, the following effect can be obtained in addition to the aforementioned effects (1A) to (1D) in the first embodiment.

(4A) The outer surface of the front conductive member 15 and the outer surface of the rear conductive member 16 have an arc-shape. This reduces wind noise.

### Fifth Embodiment

1. Configuration of Current Collector 1 and Collector Shoe 8

Configuration of the current collector 1 and the collector 8 is basically in common with, but partially different from the first embodiment. Hereinafter, common configuration will be omitted or explained in brief, and differences in the configuration will be mainly explained.

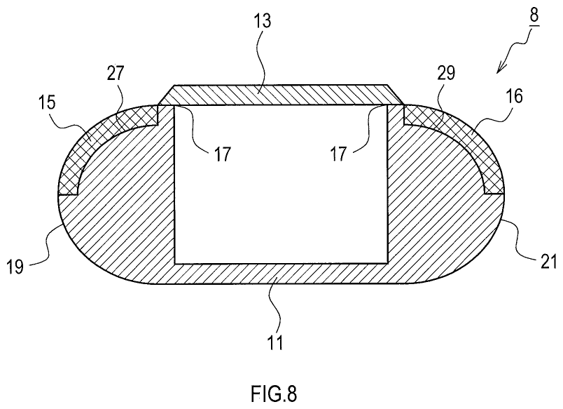

As shown in FIG. 8, the front surface 19 and the rear surface 21 basically have an arc-shape when viewed in the vertical cross section orthogonal to the width direction except for portions of a front recess 27 and a rear recess 29, which will be explained later.

The shoe body 11 comprises the front recess 27 and the rear recess 29. The front recess 27 is on the front surface 19 and has a shape which is recessed relative to the surrounding portion of the front surface 19. The front recess 27 is disposed above the center of the front surface 19 in the up-down directions. The rear recess 29 is on the rear surface 21 and has a shape which is recessed relative to the surrounding portion of the rear surface 21. The rear recess 29 is disposed above the center of the rear surface 21 in the up-down directions.

The front conductive member 15 and the rear conductive member 16 have a curved shape when viewed in the vertical cross section orthogonal to the width directions. The front conductive member 15 is entirely fitted into the front recess 27. The rear conductive member 16 is entirely fitted into the rear recess 29.

When viewed in the vertical cross section orthogonal to the width directions, the outer surface of the front conductive member 15 and the front surface 19 (excluding the front recess 27) form a continuous arc-shape as a whole; and the outer surface of the rear conductive member 16 and the rear surface 21 (excluding the rear recess 29) also form a continuous arc-shape as a whole.

3. Effect of Current Collector 1 and Collector Shoe 8

According to the fifth embodiment, which is explained above in detail, the following effects can be obtained in addition to the aforementioned effects (1A) to (1D) in the first embodiment.

(5A) The front conductive member 15 is fitted into the front recess 27, and the rear conductive member 16 is fitted into the rear recess 29. Accordingly, the front conductive member 15 and the rear conductive member 16 can be inhibited from dropping from the shoe body 11.

(5B) A front end and a rear end of the collector shoe 8 have an arc-shape when viewed in the vertical cross section orthogonal to the width directions. Accordingly, the wind noise can be reduced.

### Sixth Embodiment

1. Configuration of Current Collector 1 and Collector Shoe 8

Configuration of the current collector 1 and the collector shoe 8 in the present embodiment is basically in common with, but partially different from, the configuration in the first embodiment. Hereinafter, common configuration will be omitted or explained in brief, and differences in the configuration will be mainly explained.

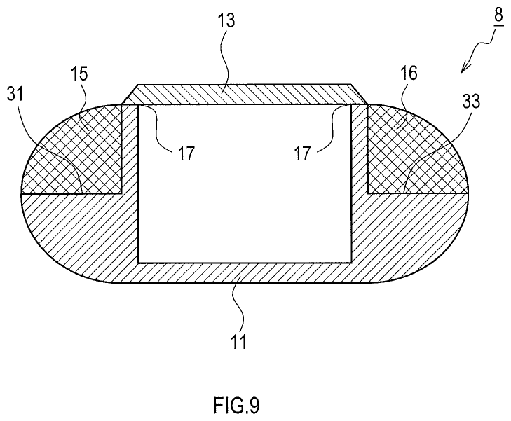

As shown in FIG. 9, the front surface 19 and the rear surface 21 have an arc-shape when viewed in the vertical cross section orthogonal to the width directions except for portions of a front recess 31 and a rear recess 33, which will be explained later.

The shoe body 11 comprises the front recess 31 and the rear recess 33. The front recess 31 and the rear recess 33 each have an L-shaped cross section. The front recess 31 is disposed above the center of the front surface 19 in the up-down directions. The rear recess 33 is disposed above the center of the rear surface 21 in the up-down directions.

The front conductive member 15 and the rear conductive member 16 have a shape of substantially a quarter circle when viewed in the vertical cross section orthogonal to the width directions. The front conductive member 15 is entirely fitted into the front recess 31. The rear conductive member 16 is entirely fitted into the rear recess 33.

When viewed in the vertical cross section orthogonal to the width directions, the outer surface of the front conductive member 15 and the front surface 19 (excluding the front recess 31) form a continuous arc-shape as a whole; and the outer surface of the rear conductive member 16 and the rear surface 21 (excluding the rear recess 33) form a continuous arc-shape as a whole.

3. Effect of Current Collector 1 and Collector Shoe 8

According to the sixth embodiment, which is explained above in detail, the following effects can be obtained in addition to the aforementioned effects (1A) to (1D) in the first embodiment.

(6A) The front conductive member 15 is fitted into the front recess 31, and the rear conductive member 16 is fitted into the rear recess 33. Accordingly, the front conductive member 15 and the rear conductive member 16 can be inhibited from dropping from the shoe body 11.

(6B) The front end and the rear end of the collector shoe 8 have an arc-shape when viewed in the vertical cross section orthogonal to the width directions. Accordingly, the wind noise can be reduced.

### Other Embodiments

The embodiments of the present disclosure are as explained above; nevertheless, the present disclosure should not be limited to the aforementioned embodiments and can be modified in various forms.

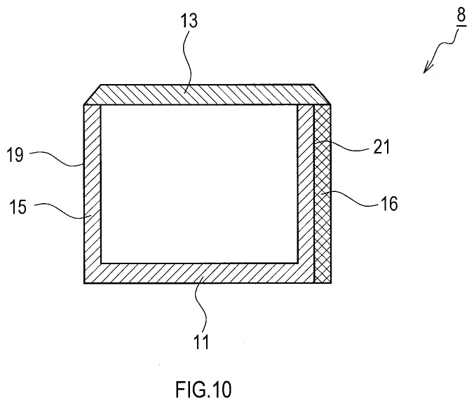

(1) As shown in FIG. 10, in the first embodiment, the rear surface 21 may have the rear conductive member 16 attached thereto, but the front surface 19 need not have the front conductive member 15 attached thereto.

Similarly, in the second to the sixth embodiments, the rear surface 21 may have the rear conductive member 16 attached thereto, but the front surface 19 need not have the front conductive member 15 attached thereto.

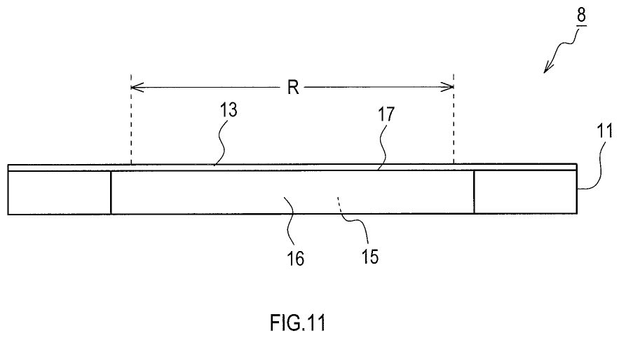

(2) As shown in FIG. 11, in the first embodiment, the front conductive member 15 and the rear conductive member 16 need not entirely cover, but may partially cover, the shoe body 11 in the width directions. In this case, it is still preferable that the front conductive member 15 and the rear conductive member 16 cover the area R.

Similarly, in the second to the sixth embodiments, the front conductive member 15 and the rear conductive member 16 need not entirely cover, but may partially cover, the shoe body 11 in the width directions.

(3) In the first, second, and fourth embodiments, the front conductive member 15 need not entirely cover, but may partially cover, the front surface 19 in the up-down directions. In this case, it is still preferable that the front conductive member 15 covers the upper end 19A; and it is more preferable that the conductive member 15 covers a half or more than the half of the area of the front surface 19.

The rear conductive member 16 need not entirely cover, but may partially cover, the rear surface 21 in the up-down directions. In this case, it is still preferable that the rear conductive member 16 covers the upper end 21A; and it is more preferable that the rear conductive member 16 covers a half or more than the half of the area of the rear surface 21.

(4) In the first to sixth embodiments, the shoe body 11 itself need not have distinctively identified front side and rear side. In this case, one side surface of the shoe body 11 in either side of the front-rear directions may be identified as the front surface 19, and the opposite side surface may be identified as the rear surface 21.

(5) In the first to sixth embodiments, the shape, size, position of attachment, thickness, material, and so on of the front conductive member 15 and the rear conductive member 16 can be appropriately determined.

1. A collector shoe comprising:
a shoe body,
a sliding plate disposed on a top surface of the shoe body,
and an electrically conductive member disposed on a front and/or rear side surface of the shoe body.

2. The collector shoe according to claim 1,
wherein the electrically conductive member is configured to cover at least an upper end of the side surface.

3. The collector shoe according to claim 1,
wherein the electrically conductive member is configured to cover at least a half of the side surface in up-down directions.

4. The collector shoe according to any one of claim 1,
wherein the electrically conductive member is configured to cover at least an area of the side surface in width directions, the area being where the sliding plate contacts an overhead line.

5. The collector shoe according to any one of claim 1,
wherein the shoe body comprises a recess on the side surface, and
wherein at least a part of the electrically conductive member fits into the recess.

6. The collector shoe according to any one of claim 1,
wherein an outer surface of the electrically conductive member comprises an arc-shape when viewed in a vertical cross section along the front-rear directions.

7. A current collector comprising:
a collector shoe comprising:
a shoe body,
a sliding plate disposed on a top surface of the shoe body,
and an electrically conductive member disposed on a front and/or rear side surface of the shoe body.
